(19) United States
(12) Patent Application Publication
(10) Pub. No.: US 2008/0064803 A1
(43) Pub. Date: Mar. 13, 2008

(54) PROTECTIVE SPACE COATINGS

(76) Inventors: Mark D. Soucek, Akron, OH (US); David P. Dworak, East Hartford, CT (US)

Correspondence Address: ROETZEL AND ANDRESS, 222 SOUTH MAIN STREET, AKRON, OH, 44308, US

(21) Appl. No.: 11/751,309

(22) Filed: May 21, 2007

Related U.S. Application Data
(60) Provisional application No. 60/801,774, filed on May 19, 2006.

(51) Int. Cl. C08K 3/08

(52) U.S. Cl. 524/440; 524/588

(57) ABSTRACT

The present invention is generally directed to protective coatings, especially those which are capable of being used to coat space vehicles and/or satellites. In one embodiment, the present invention relates to methyl, cyclopentyl, and/or cyclohexyl polysiloxane ceramer coatings. In another embodiment, the present invention relates to methods for preparing creamer compounds.

### RELATED APPLICATION DATA

This application claims priority to previously filed U.S. provisional patent application No. 60/801,774, filed on May 19, 2006 and entitled “Protective Space Coatings”, which is incorporated in its entirety herein by reference.

### FIELD OF THE INVENTION

The present invention is related to protective coatings, especially those which are capable of being used to coat space vehicles and/or satellites. In one embodiment, the present invention relates to methyl, cyclopentyl, and/or cyclohexyl polysiloxane ceramer coatings. In another embodiment, the present invention relates to methods for preparing creamer compounds.

### BACKGROUND OF THE INVENTION

In general, low earth orbit (LEO) and/or geosynchronous orbit (GEO) environments are not suitable for organic materials. This is due to the presence of atomic oxygen, high-energy particles, and deep UV light, which are able to degrade polymeric organic resins. Accordingly, inorganic and/or ceramer materials are more appropriate inasmuch as they are more resistant to the harsh conditions of space. Until now, some compounds of this type, for example methyl, cyclopentyl, and/or cyclohexyl polysiloxane ceramer coatings have been unknown in the art. This is due, in part, to a difficulty in preparing such compounds.

Thermoplastic and thermosetting polymers are used to form a wide variety of structures for which properties such as abrasion resistance, optical clarity (i.e., good light transmittance) and/or the like, are desired characteristics. Examples of such structures include camera lenses, eyeglass lenses, binocular lenses, retroreflective sheeting, automobile windows, building windows, train windows, boat windows, aircraft windows, vehicle headlamps and taillights, display cases, eyeglasses, watercraft hulls, road pavement markings, overhead projectors, stereo cabinet doors, stereo covers, furniture, bus station plastic, television screens, computer screens, watch covers, instrument gauge covers, bakeware, optical and magneto-optical recording disks, and the like. Examples of polymer materials used to form these structures include thermosetting or thermoplastic polycarbonate, poly(meth)acrylate, polyurethane, polyester, polyamide, polyimide, phenoxy, phenolic resin, cellulosic resin, polystyrene, styrene copolymer, epoxy, and the like.

Many of these thermoplastic and thermosetting polymers have excellent rigidity, dimensional stability, transparency, and impact resistance, but unfortunately have poor abrasion resistance. Consequently, structures formed from these materials are susceptible to scratches, abrasion, and similar damage.

To protect these structures from physical damage, a tough, abrasion resistant “hardcoat” layer may be coated onto the structure. Many previously known hardcoat layers incorporate a binder matrix formed from free-radically curable prepolymers such as (meth)acrylate functional monomers. Such hardcoat compositions have been described, for example, in Japanese patent publication JP 02-260145, U.S. Pat. Nos. 5,541,049, and 5,176,943. One particularly excellent hardcoat composition is described in WO 96/36669 A1. This publication describes a hardcoat formed from a “ceramer” used, in one application, to protect the surfaces of retroreflective sheeting from abrasion. As defined in this publication, a ceramer is a composition having inorganic oxide particles, e.g., silica, of nanometer dimensions dispersed in a binder matrix.

Many ceramers are derived from aqueous sots of inorganic oxide particles according to a process in which a free-radically curable binder precursor (e.g., one or more different free-radically curable monomers, oligomers, and/or polymers) and other optional ingredients (such as surface treatment agents that interact with the inorganic oxide particles, surfactants, antistatic agents, leveling agents, initiators, stabilizers, sensitizers, antioxidants, crosslinking agents, crosslinking catalysts, and the like) are blended into the aqueous sol. The resultant ceramer composition may then be dried to remove substantially all of the water. The drying step may also be referred to as “stripping”. An organic solvent may then be added, if desired, in amounts effective to provide the ceramer composition with viscosity characteristics suitable for coating the ceramer composition onto the desired substrate. After coating, the ceramer composition can be dried to remove substantially all of the solvent and then exposed to a suitable source of energy to cure the free-radically curable binder precursor, thereby providing the desired, abrasion resistant hardcoat layer on the substrate.

Although such ceramer compositions, upon curing, generally provide at least some level of abrasion resistance to a substrate, they generally do not provide appreciable stain resistance or oil and/or water repellency. As a result, substrates comprising a cured ceramer composite are susceptible to staining due to prolonged contact with oil, water or other stain causing agents. Such staining impairs the optical clarity and appearance of the substrate. It is therefore desirable to incorporate agents into ceramer compositions that will provide the ceramer composition, upon, curing, with stain, oil and/or water resistance, while still maintaining the desired hardness and abrasion resistance characteristics of the resultant, cured ceramer composite.

Thus, there is a need in the art for creamer coatings that, among other things, are suitable for use in space environments.

### SUMMARY OF THE INVENTION

The present invention is generally directed to protective coatings, especially those which are capable of being used to coat space vehicles and/or satellites. In one embodiment, the present invention relates to methyl, cyclopentyl, and/or cyclohexyl polysiloxane ceramer coatings. In another embodiment, the present invention relates to methods for preparing creamer compounds.

As noted above, the present invention generally relates to protective coatings. More particularly, the present invention relates to protective polysiloxane coatings that are particularly suitable for, among other things, vehicles and/or satellites in low earth and geosynchronous orbits. Some embodiments of the present invention include an inorganic/organic hybrid coating, known as a ceramer, that is fabricated using a polysiloxane binder and nanophase silicon/metal-oxo-clusters derived from sol-gel precursors. Such coatings can be synthesized using hydrolytic polycondensation and hydrosilation methods thereby enabling the synthesis of a wide variety of customized/tailored polysiloxanes. Features of coatings within the scope of the present invention include, without limitation, the ability to self-heal, deflect high-energy particles, protect against deep UV-light, and optical transparency.

### BRIEF DESCRIPTION OF THE FIGURES

FIG. 1 is a diagram of the self-healing mechanism using atomic oxygen;

FIG. 2 is a Depiction of in situ Silicon/Metal-Oxo-Cluster Formation for Nanoscale Reinforcement in Ceramer Coatings;

FIG. 3 is an FTIR spectrum of cyclopentyldichlorosilane;

FIG. 4 is a drawing showing a nanophase reinforced ceramer coating;

FIG. 5 is a drawing showing the formation and function of protective a silicon oxide layer and silicon/metal-oxo-clusters;

FIG. 6 is a graph showing the temperature effect on the rate of propagation (Rₚ);

FIG. 7 is a graph showing the effect of UV light on Rₚ;

FIG. 8 is a graph showing the effect of exposure time on Rₚ;

FIG. 9 is a graph showing the effect of TEOS concentration on Rₚ;

FIG. 10 is a photograph of a sample holder for exposing samples to atomic oxygen;

FIG. 11 is a graph of thermal gravimetric analysis data from a ceramer coating having a 5% sol-gel precursor content;

FIG. 12 is a graph showing XPS data from a cross-linked methyl substituted polysiloxane before and after atomic oxygen exposure;

FIG. 13 is a pair of atomic force microscopy (AFM) images of a sample with 5% (w/w) sol-gel precursor added prior to casting;

FIG. 14 is a) a pair of photographs showing a ceramer coating on Kapton H and fused silica after atomic oxygen exposure at a moderate fluence level (2.22×10²¹ atoms/cm²), and (b) a pair of photographs showing a DC 93-500 coating on Kapton H and fused silica after atomic oxygen exposure at a moderate fluence level (2.22×10²¹ atoms/cm²);

FIG. 15 is a) a pair of photographs showing a ceramer coating on Kapton H and fused silica after atomic oxygen exposure at a high fluence level (2.22×10²¹ atoms/cm²), and (b) a pair of photographs showing a DC 93-500 coating on Kapton H and fused silica after atomic oxygen exposure at a high fluence level (2.22×10²¹ atoms/cm²);

FIG. 16 is a set of plots showing mass loss of various materials as a function of fluence;

FIG. 17 is a pair of AFM images showing the a) abraded and b) re-oxidized ceramer coating;

FIG. 18 is a pair of SEM photographs showing the ceramer coating after being a) scratched and b) re-oxidized;

FIG. 19 is an SEM photograph of a ceramer that has been subjected to high fluence (1.38×10²² atoms/cm²) and exhibits some delamination and micro-cracking;

FIG. 20 is a set of plots showing the effect of atomic oxygen exposure on a ceramer coating on fused silica in terms of a) absorbance, b) transmittance, and c) reflectance;

FIG. 21 is a set of plots showing the effect of atomic oxygen exposure on a DC 93-500 coating on fused silica in terms of a) absorbance, b) transmittance, and c) reflectance; and

FIG. 22 is a set of plots showing the effect of microcracks on transmittance in samples of a) ceramer on fused silica, and b) DC 93-500 on fused silica.

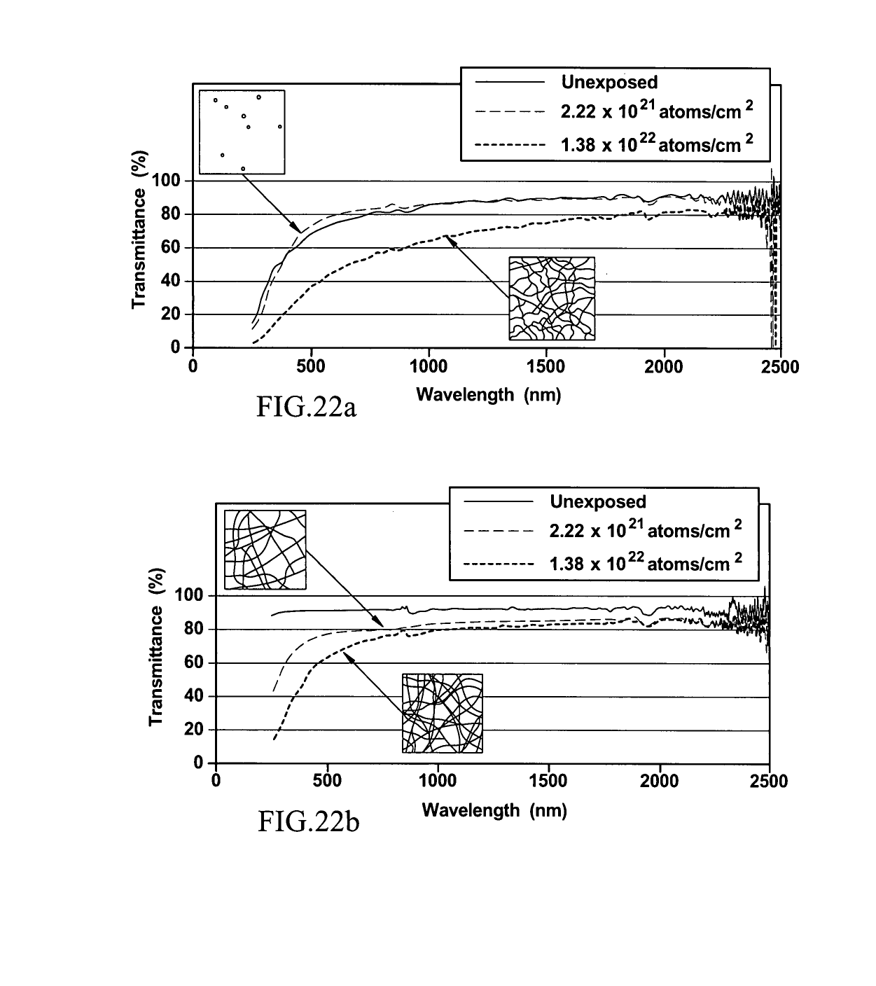

### DETAILED DESCRIPTION OF THE INVENTION

As used herein, the term ceramer includes inorganic/organic hybrid materials that are part ceramic and part polymer. Ceramers can comprise one or more of a wide range of ceramics such as silica, titania, zirconia, clays, various metal oxides, and mixtures and combinations thereof, both synthetic and naturally occurring. Additionally, ceramers can comprise one or more of a wide range of organic polymers and/or substituents. In another embodiment, ceramers can provide a uniformly distributed nanophase within a continuous organic phase. In some embodiments, ceramers of the present invention can protect space vehicles from atomic oxygen, UV radiation and high energy particles by forming nanophase silicon/metal-oxo-clusters in situ.

The degradation of carbon-based materials in LEO is due to the presence of ground state atomic oxygen, various forms of radiation, and particulate matter that impacts the vehicle. The UV radiation that is present in LEO can cleave organic bonds, which brings about chain scission and cross-linking reactions in organic polymeric materials. This can lead to changes in thermal conductivity, and optical and mechanical properties, as well as embrittlement, and decreased strength. Other factors that affect organic materials in space include thermal fluctuations, radiation, vacuum, particulate matter, and micrometeoroids and debris. The coatings of the present invention are resistant to some or all of these factors.

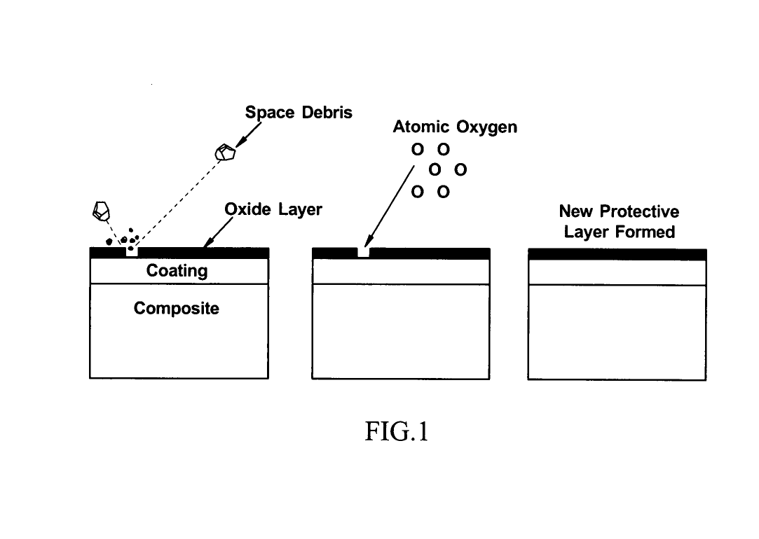

Siloxane polymers in LEO have erosion rates one to two orders of magnitude lower than that of organic polymers under the same conditions. Furthermore, when siloxane polymers are exposed to atomic oxygen they tend to form a protective silicon dioxide barrier, unlike organic polymers, which corrode. For instance, exposure of polyhedral oligomeric silsesquioxanes-siloxane (POSS) copolymer thin films to atomic oxygen results in an initial attack on the tethered organic groups followed by formation of a silica surface layer. The silica layer blocks atomic oxygen thereby preventing further degradation. In addition to providing enhanced atomic oxygen resistance, silica-forming polymers possess a self-healing mechanism whereby the coating can repair itself if it is, for instance, scratched or etched (see FIG. 1). The general structure of a T⁸ silsesquioxane is shown below:

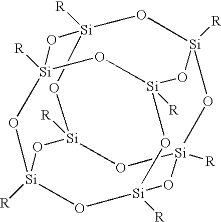

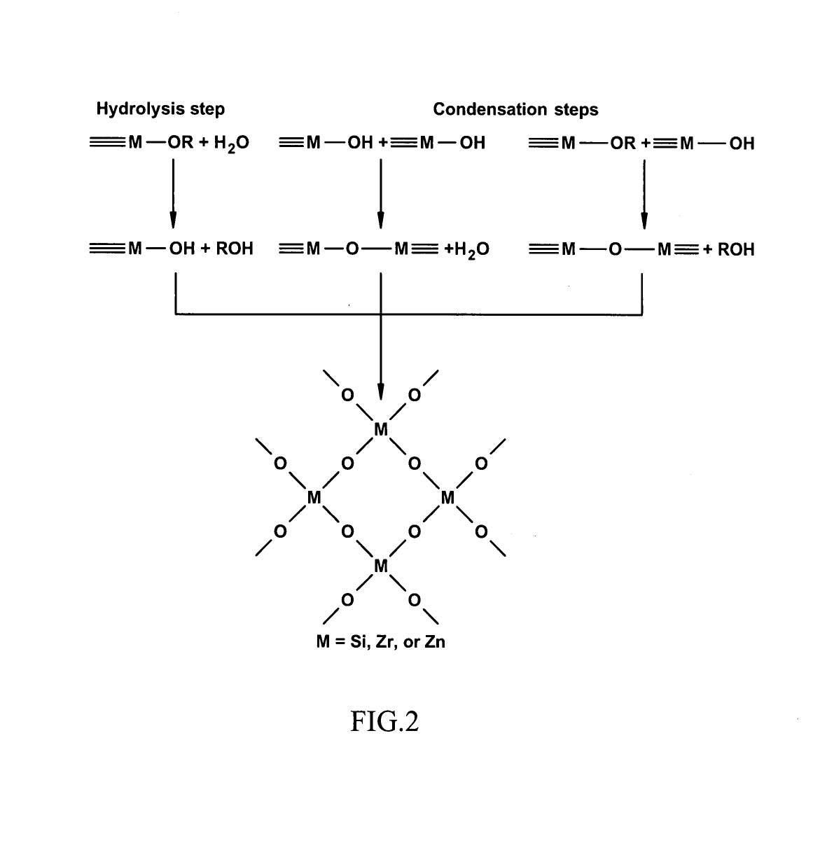

In some embodiments of the present invention, silicon/metal-oxo-clusters are formed through a series of hydrolysis and condensation reactions between sol-gel precursors, as illustrated in FIG. 2. The size of the clusters can be adjusted by controlling the reaction conditions, and/or reaction rate. The siloxane is functionalized through hydrosilation with cycloaliphatic epoxides and alkoxy silanes. The cycloaliphatic epoxide provides a cross-linking site for cationic UV-induced cure. Silanol groups can react with the cycloaliphatic epoxide to further reinforce the network. According to the present invention, the size of the colloidal particles can be adjusted by and/or controlled by adjusting and/or controlling the coupling group, e.g., alkoxysilanes.

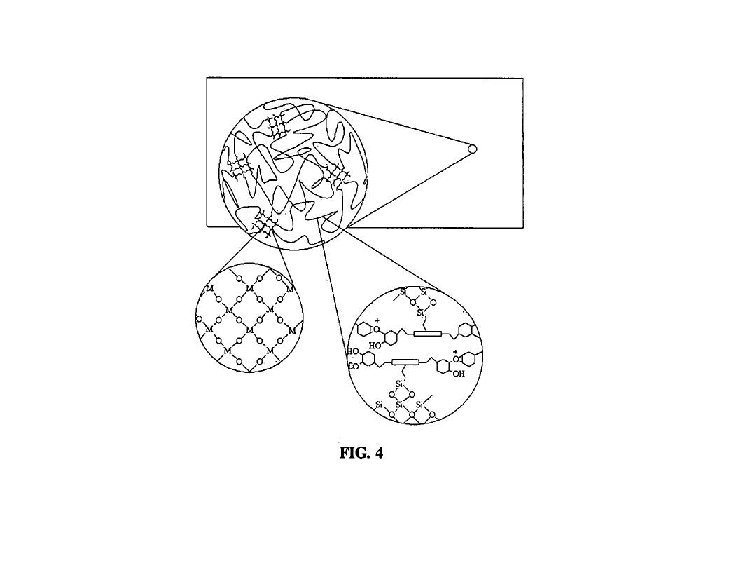

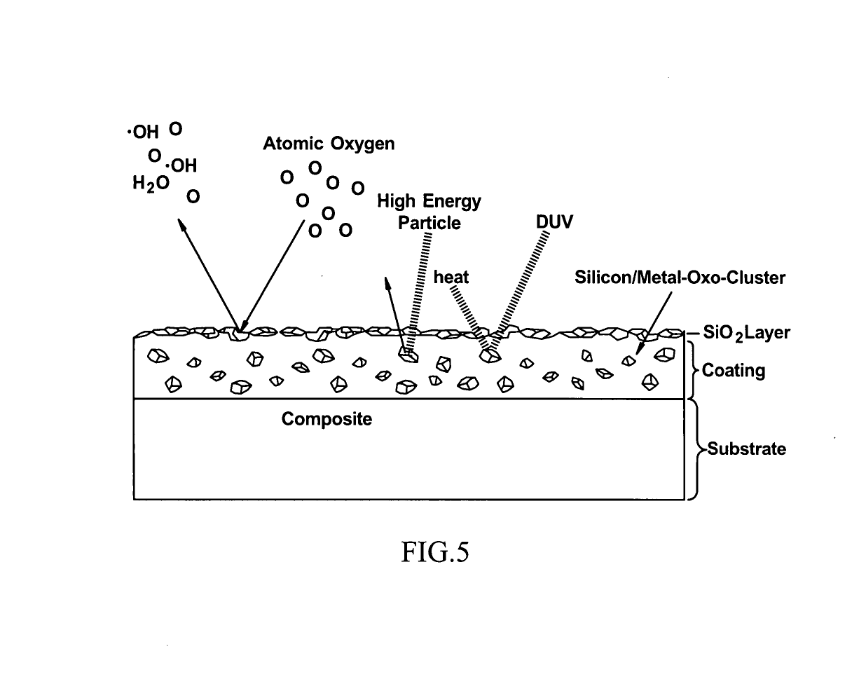

The curing process results in a strong interlocking network comprising a cross-linked organic phase with interconnected silicon/metal-oxo-clusters (FIG. 4). Exposing the coating to atomic oxygen results in forming a protective layer of silicon oxide, which forms an oxide layer that serves as a protective barrier. In some embodiments, incorporation of silicon/metal-oxo-clusters into the coating protects against atomic oxygen erosion, high energy particles, and/or deep ultraviolet (DUV) radiation (see FIG. 5).

In some embodiments, tetraethylorthosilicate (TEOS) is used as a sol-gel precursor. TEOS aids in miscibility and provides a site for interaction with the metal/silicon-oxo-cluster. According to some embodiments, TEOS is oligomerized to avoid volatilization. Additionally, TEOS oligomers are amenable to photo-induced cationic polymerization of cycloaliphatic epoxides.

### EXAMPLE PREPARATIONS

Except where otherwise noted, the following applies to each of the example preparations set forth herein. Octamethylcyclotetrasiloxane, tetramethylcyclosiloxane, tetramethyldisiloxane, dichlorosilane, and vinyl triethoxysilane can be purchased from Gelest, Inc. and are used as supplied. Wilkinson's catalyst, cyclopentene, tetraethylorthosilicate, and 4-vinyl-1-cyclohexene 1,2-epoxide can be purchased from Aldrich and are used as supplied. Toluene, supplied by Aldrich Chemical Co., is distilled in order to eliminate any impurities. The photoinitiator, Iodonium, (4-methylphenyl)[4-(2-methylpropyl)phenyl]hexafluorophosphate(1-) 75% solution in propylene carbonate, is used as received. A structure for this compound is shown below: 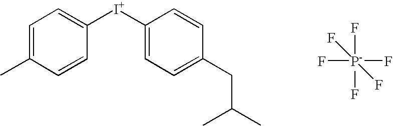
This photoinitiator solution can be obtained from Ciba Specialty Chemicals and is sold under the trademark IRGACURE 250. Air sensitive materials are transferred and weighed in an inert atmosphere dry box under argon.

(1) Synthesis of Compound 1: Poly(dimethylsiloxane-co-methylhydrosiloxane) Hydride Terminated:

The following components are added to a three neck round bottom flask equipped with a reflux condenser and nitrogen inlet/outlet ports: octamethylcyclotetrasiloxane (90 g), tetramethylcyclosiloxane (5.33 g), tetramethyldisiloxane (0.67 g), and concentrated sulfuric acid (2.5 mL). The solution is stirred at room temperature, under nitrogen, for about eight hours. Sodium bicarbonate is added to neutralize the acid, and the solution is filtered to obtain compound 1. The following M_{w} and polydispersity index (PDI) are obtained by gel permeation chromatography (GPC): M_{w}=47,000, PDI=2.15. H¹ NMR shows a peak at 4.6 ppm and FTIR shows a strong peak at 2160 cm⁻¹, which are both indicative of the Si-H functionality.

(2) Cycloaliphatic Epoxide and Alkoxy Silane Functionalization of Compound 1:

The following are added to a three neck round bottom flask equipped with nitrogen inlet/outlet ports, a reflux condenser, and septum: compound 1 (30 g), 4-vinyl-1-cyclohexene diepoxide (20 g), vinyl triethoxysilane (2 g), and Wilkinson's catalyst (0.004 g). Distilled toluene (30 g) is added via cannula. The reaction is held at about 75° C. with an oil bath, and it is mechanically stirred. The disappearance of the Si—H functionality is monitored through FTIR. The disappearance of the peak at 2160 cm⁻¹ indicates that the reaction is complete. Any solvent and unreacted starting materials are removed under vacuum and the reaction product is verified through H¹ NMR.

(3) Synthesis of TEOS Oligomers:

The following materials are added to a single neck round bottom flask: TEOS (100 g), ethanol (88 g) and distilled water (8 g). Hydrochloric acid (0.5 g) is then added dropwise while the mixture is mechanically stirred. The reaction is stirred for 48 hours at room temperature. The solvent is removed under vacuum to yield TEOS oligomers. The products were characterized through H¹ NMR.

(4) Synthesis of Compound 2: Poly(dicyclopentylsiloxane-co-cyclopentyl-Hydrosiloxane), Hydride Terminated Siloxane:

(4a) Synthesis of Cyclopentyldichlorosilane:

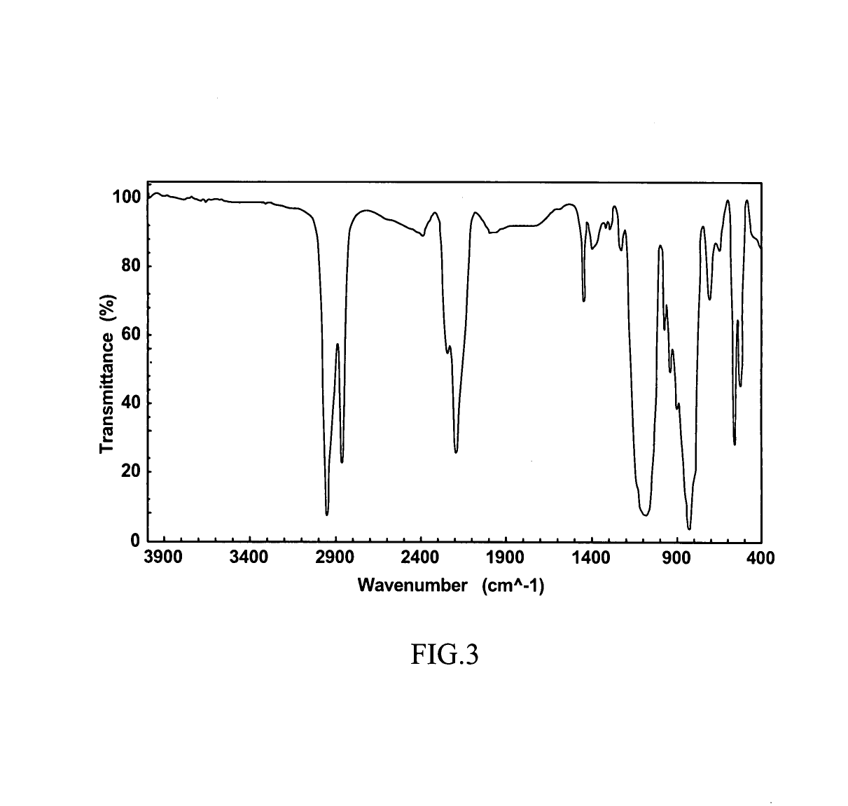

A stainless steel bomb is charged with cyclopentene (5 g) and Wilkinson's catalyst (0.06 g), cooled in a liquid nitrogen bath, and evacuated. Dichlorosilane (5 mL) is condensed in a calibrated tube and distilled into the bomb through the inlet valve. The bomb is then allowed to warm to room temperature, and then heated for 15 hours at about 70° C. The bomb is then allowed to cool. The reaction produces a clear, light yellow liquid. The FTIR spectrum shows a strong Si-H peak at about 2100 cm⁻¹ and a Si—Cl₂ peak at about 500 cm⁻¹ as shown in FIG. 3.

(4b) Synthesis of Cyclic n-mers of Compound 2:

Saturated aqueous sodium bicarbonate (5 mL) is added to a round bottom flask and cooled to about 10° C. Cyclopentyldichlorosilane (5 mL) is added dropwise to yield a thick slurry. Any remaining water is filtered off. The product is added to boiling toluene and then filtered to remove any cross-linked compounds. The solvent is then removed via vacuum to yield a white solid, and analyzed by FTIR. FTIR showed the disappearance of the Si—Cl₂ peak and a slight broadening of the band at 1000 cm⁻¹ which represents cyclic Si—O—Si compounds.

Reaction Rate; Photo Differential Scanning Calorimetry:

Photodifferential scanning calorimetry (PDSC) is used herein to show the effects that temperature, UV light intensity, sol-gel precursor concentration, and exposure time have on polymerization rate. According to some embodiments, higher reaction rates produce higher final percent conversions. PDSC is also used to determine heat of reaction exotherms, which can be used to calculate polymerization rate and associated rate constants.

In some embodiments, the cure kinetics can be studied with a Thermal Analysis Q 1000 DSC equipped with a photocalorimetric accessory. The accessory includes transfer optic cables capable of carrying UV light, and a monochromator capable of selecting specific wavelengths and/or very narrow bands about selected wavelengths. The initiation light source is a 100 W mercury arc lamp. One of ordinary skill in the art is would readily recognize that a variety of wavelengths can be appropriate for such a study, and can be different from one compound to another. In some embodiments, appropriate wavelengths include ultraviolet light below about 300 nm.

A wide variety of photosensitizers can be used to sensitize samples to UV light. In some embodiments one or more photosensitizers shift the initiating wavelength into the UV or deep UV region. In other embodiments anthracene and/or phenanthrene is used to shift the initiating wavelength into the visible region. In still other embodiments, photosensitizers can include any compound that forms a triplet state in response to visible light exposure. One of ordinary skill in the art is able to readily select particular photosensitizers based on this criterion.

Polymerization reactions within the scope of the present invention are run isothermally at various temperatures. For the purpose of reaction rate determinations, samples sizes can be between about 1 to 5 mg in order to limit the total heat released. The samples are placed in hermetic uncovered aluminum DSC pans and cured with various UV intensities and exposure times.

Rate of Polymerization:

Since PDSC experiments measure the overall heat of reaction, the heat flow is representative of an overall activation energy (E_{R}), which includes initiation (E_{I}), propagation (E_{P}), and termination (E_{T}):
E_{R}=E_{P}+E_{I}−E_{T} (1)

Equation (1), presumes that carbocations are produced throughout the reaction, i.e. by photoinitiation. In some embodiments, rate constant determinations for photosensitized reactions show that the photosensitizer is not completely consumed until after the exotherm peak maximum. Thus, equation (1) can be used to represent the overall activation energy for the photopolymerization reaction. Therefore, the rate of propagation (Rₚ) is proportional to the height of the PDSC exotherm. The propagation rate can be calculated with equation (2). The rate obtained has units of moles of epoxide per second.
Rₚ=(d[E]/dt)=(height of exotherm(Wg⁻¹)×ρ)/ΔHₚ (2)

In equation (2), [E] is the epoxy concentration. The rate of propagation is given by a propagation rate constant (kₚ) multiplied by the carbocation concentration [C+] and the epoxy concentration.
Rₚ=(d[M]/dt)
Rₚ=kₚ[C+][E]
Rₚ=[A]₀·(kₚkᵢ*/kₜ−kᵢ*)·(e^{-ki·t}−e^{-kt·t})[E] (3)

In equation (3) [A] is anthracene concentration, kᵢ is the initiation rate constant, kᵢ* is the rate constant for carbocation formation, and kₜ is the termination rate constant. It is possible to have more than one propagating species having different reactivities. Therefore, equation (3) arrives at a general propagation rate constant that accounts for each type of propagating species.

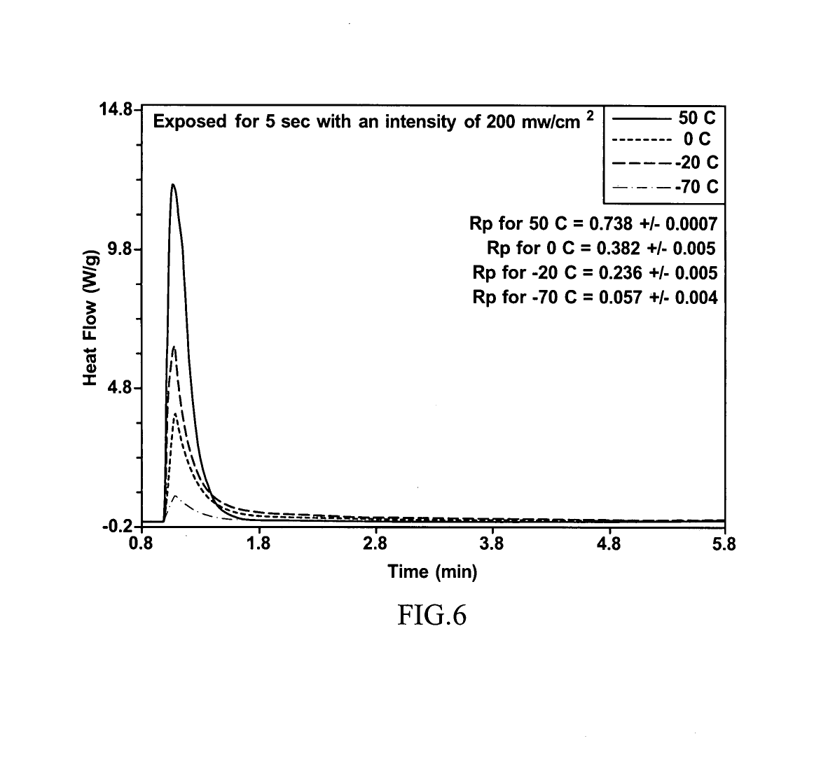

FIGS. 6, 7, 8, and 9 illustrate how temperature, intensity, exposure time, and TEOS concentration affect the rate of polymerization of a single composition. FIG. 6 is an overlay of exotherms for the cationic polymerization of compound 1 with 0.01 wt % anthracene and 3 wt % photoinitiator at temperatures ranging from 50° C. to about −70° C. Some samples also contained 5 wt % TEOS oligomers. FIG. 6 also shows that the rate of polymerization increases with temperature, which is indicated by the fact that the exotherms indicate a larger integrated heat as temperature is increased. The increase in Rₚ results, in part, from increased chain mobility.

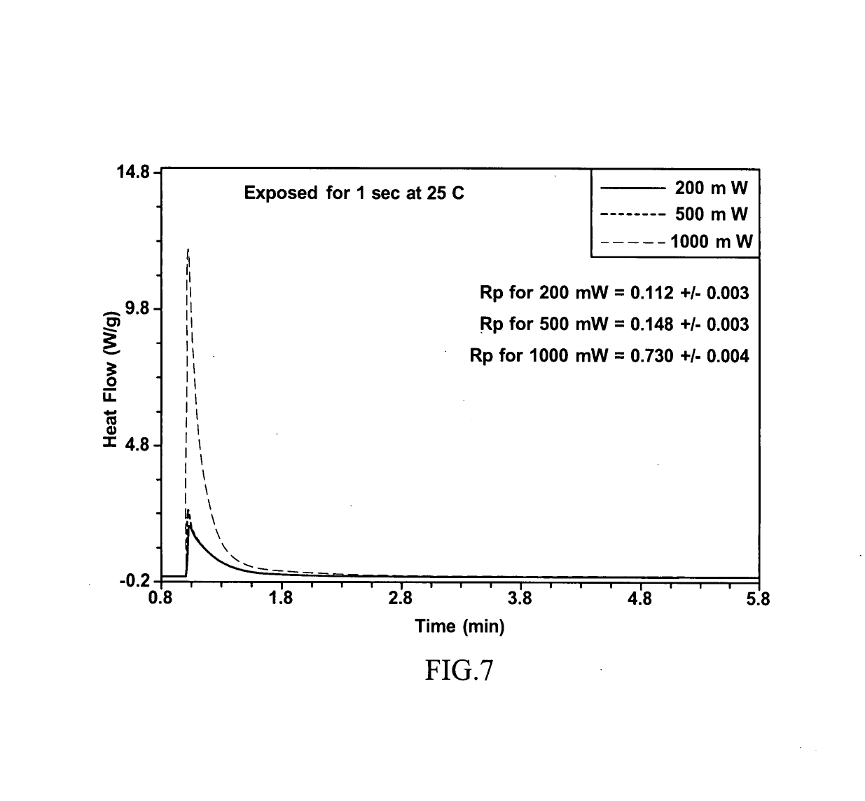

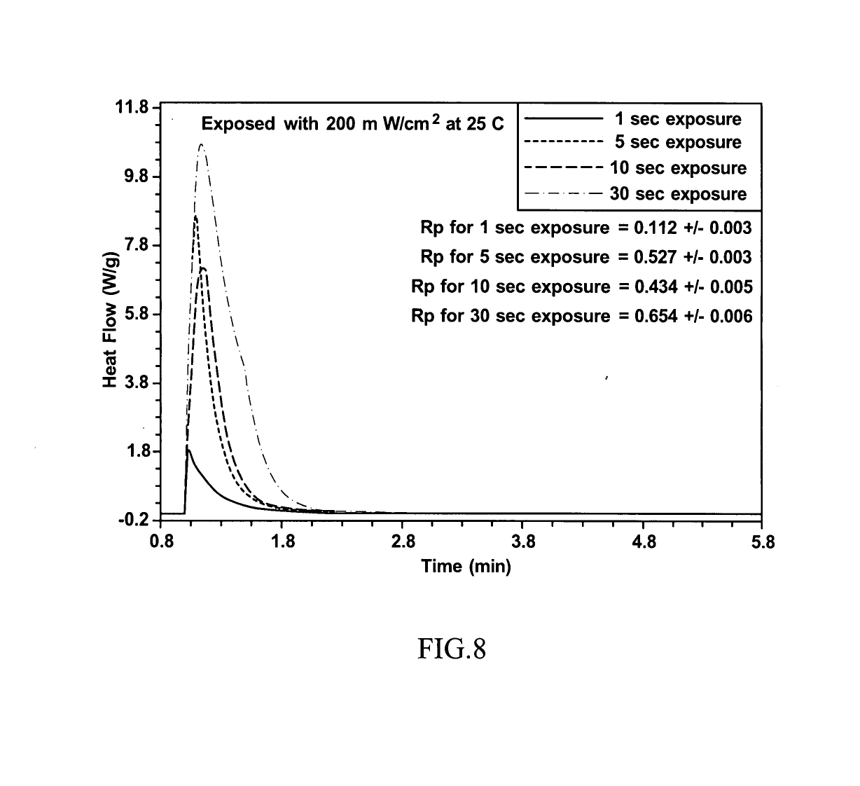

FIG. 7 shows the effect of variations in UV light intensity from about 200 to 1000 mW/cm². Reaction rate increases with UV light intensity. This is a result of the higher intensity producing more protons, which increases the rate of polymerization. It is important to note that the exotherms resulting from 200 and 500 mW/cm² UV intensities are very similar and their rates of polymerization differ by approximately 0.030 moles of epoxy/L·s. Intensity needs to be doubled in order to see a substantial difference in the rate of polymerization. The effect of the duration of UV light exposure is shown in FIG. 8, which displays the results of varying the exposure time from 1 to 30 seconds.

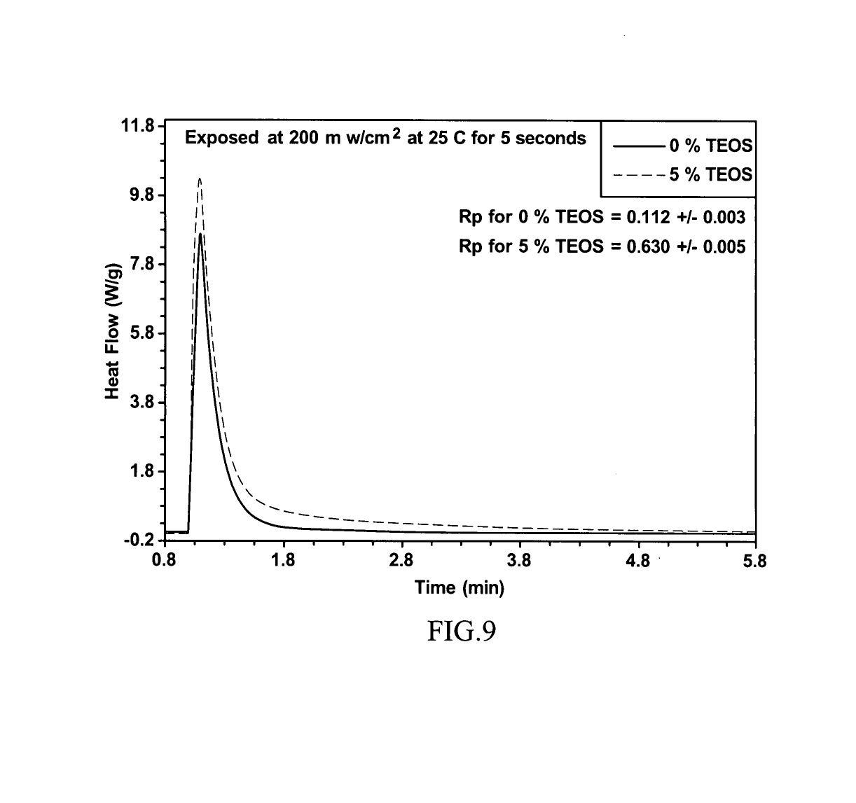

Increased exposure time produces a greater integrated heat area, and therefore a higher reaction rate. FIG. 8 shows that the rate of polymerization increases with exposure time, which is due to the production of more initiating species. Additionally, FIG. 9 shows that the rate of polymerization (compound 1) also increases with TEOS concentration. Particularly, the rate of polymerization is about 1.5 times greater with 5% TEOS in comparison to samples having no TEOS. This is due in part to the polysiloxane chain undergoing polymerization, and also to additional cross-linking caused by in situ silicon/metal-oxo-cluster formation. Table I summarizes the rates of polymerizations found for compound 1 under various conditions.

TABLE I
Compound 1 PDSC Data

| | | | TEOS | Height of | Exotherm | Rp |
|---|---|---|---|---|---|---|
| Exposure Time | Intensity | Temperature | Concentration | Exotherm | Area | (moles of |
| (seconds) | (mw/cm²) | (° C.) | (Wt %) | (Wg⁻¹) | (Jg⁻¹) | epoxide/L · s) |
| 1 | 200 | 25 | 0 | 1.84 | 25.19 | 0.112 |
| 1 | 500 | 25 | 0 | 2.44 | 26.08 | 0.148 |
| 1 | 1000 | 25 | 0 | 12.00 | 97.39 | 0.730 |
| 5 | 200 | 25 | 0 | 8.66 | 106.80 | 0.527 |
| 5 | 1000 | 25 | 0 | 25.62 | 246.20 | 1.558 |
| 10 | 200 | 25 | 0 | 7.13 | 117.30 | 0.434 |
| 10 | 1000 | 25 | 0 | 20.80 | 252.50 | 1.265 |
| 30 | 200 | 25 | 0 | 10.76 | 251.20 | 0.654 |
| 30 | 500 | 25 | 0 | 15.86 | 324.30 | 0.965 |
| 30 | 1000 | 25 | 0 | 53.06 | 1055.00 | 3.227 |
| 5 | 200 | −70 | 0 | 0.94 | 11.84 | 0.057 |
| 5 | 200 | −20 | 0 | 3.88 | 51.54 | 0.236 |
| 5 | 200 | −5 | 0 | 3.88 | 49.84 | 0.236 |
| 5 | 200 | 0 | 0 | 6.27 | 78.97 | 0.382 |
| 5 | 200 | 50 | 0 | 12.14 | 151.80 | 0.738 |
| 1 | 200 | 25 | 5 | 4.22 | 40.15 | 0.258 |
| 5 | 200 | 25 | 5 | 10.32 | 143.30 | 0.630 |
| 10 | 200 | 25 | 5 | 13.14 | 186.80 | 0.802 |
| 5 | 200 | −20 | 5 | 5.18 | 75.79 | 0.316 |
| 5 | 200 | 0 | 5 | 5.55 | 93.19 | 0.338 |
| 5 | 200 | 50 | 5 | 14.25 | 198.00 | 0.869 |

Coating

In some embodiments, the coating of the present invention is applied to a substrate by spin coating. For instance, one appropriate spin coating method comprises the following. The functionalized polysiloxane is diluted with toluene (25% wt/wt) thereby sufficiently reducing the viscosity. Sol-gel precursor (5% wt/wt) and photo initiator (3% wt/wt) arc added to the diluted polysiloxane and thoroughly mixed. A substrate (e.g., a piece of Kapton H, fused silica, or the like) of appropriate size (e.g., about 10 cm diameter) is mounted onto a spinning stage and spun at a very high speed. The uncured polysiloxane solution is dropped onto the center of the spinning Kapton sample. The sample is removed from the stage and passed through a UV-curing chamber at a belt speed of about 25 ft/min and an average intensity of about 150 mW/cm². For the purpose of comparison to the present invention, DC 93-500 is coated in the same manner, and placed in an oven at 80° C. for 6 hours to cure. Fused silica panels are also coated by both polymers in the same manner. The coating thickness is measured with a coating thickness gauge and by atomic force microscopy (AFM), and found to be about 2 μm average thickness in each sample.

Durability Testing

(a) Thermal Stability:

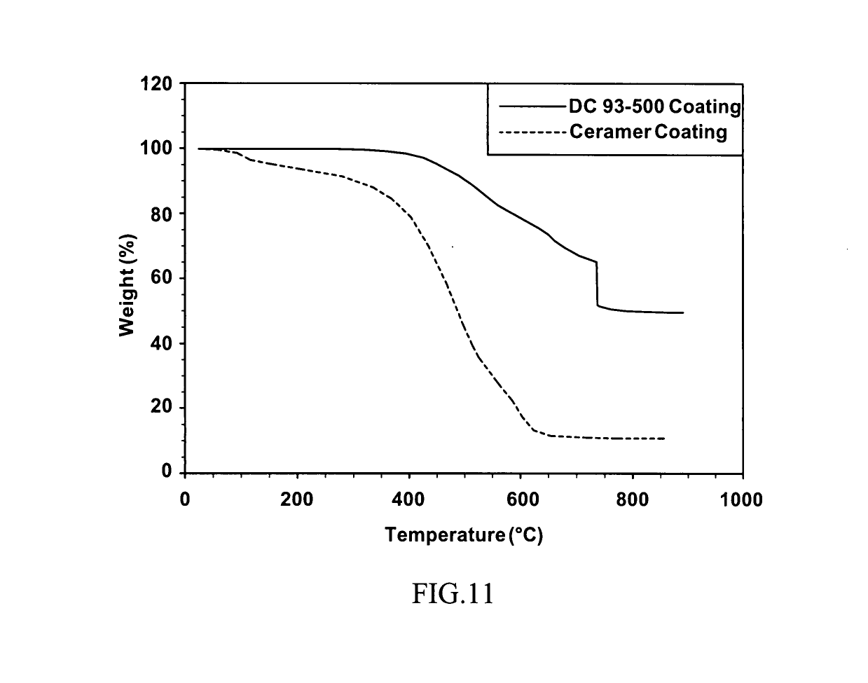

The thermal stability of the present invention is compared to DC 93-500 by thermal gravimetric analysis (TGA). Irreversible changes to the cross-linked structure of silicone polymers occur at high temperatures due to chain scission, oxidative cross-linking, and depolymerization. Particularly, depolymerization can occur at about 400° C. in an inert atmosphere. FIG. 11 compares the thermal stability of the present invention to that of DC 93-500.

As shown in FIG. 11, thermal gravimetric analysis (TGA) of the cured ceramer coating indicates that low molecular weight oligomers are lost in the early stages of the analysis. This is evident from the gradual decrease in weight percent up to about 400° C. The DC 93-500 does not exhibit this weight loss in the early stages of the analysis because it is vacuum stripped during production, which eliminates any low molecular weight species. Depolymerization occurs in both samples near 400° C. The DC 93-500 sample exhibits a slightly higher degradation temperature. The multiple slopes observed in the ceramer curve can be attributed to a range of molecular weights. Importantly, the ceramer generates a small amount of residue (roughly 11 wt %). This can be attributed to the silicon-oxo-clusters formed during polymerization, and to high molecular weight chains that may not have completely volatized/degraded.

The thermal degradation of the DC 93-500 is drastically different from the ceramer coating's profile. The major degradation slope starting at approximately 400° C. shows a more thermally stable compound with a broader degradation range from 400 to 730° C. as opposed to that of the ceramers, which range from about 400 to 650° C. The extreme degradation of approximately 35 wt % at 730° C. for the DC 93-500 is very unusual, but it is reproducible. This could be attributed to the sample achieving its absolute highest temperature before total decomposition of the sample. The sharp slope is then followed by a residue segment, which accounts for 50% of the remaining weight. Since the cured DC 93-500 is composed of approximately 40-60% silica of various types (dimethylvinylated, trimethylated, and methylated), these components could account for the residue left after analysis.

(b) Atomic Oxygen Exposure:

The atomic oxygen durability of the present invention is assessed in comparison to a DC 93-500 control. The first two samples comprise the ceramer of the present invention spin coated on Kapton H polyamide and fused silica substrates. The second two samples comprise DC 93-500 silicone spin coated on Kapton H and fused silica substrates. All samples are coated on both sides.

Optical property changes and mass loss are documented at effective atomic oxygen fluence levels of 2.22×10²¹ and 1.38×10²² atoms/cm². Kapton H witness samples are used to determine the effective atomic oxygen fluence as described in ASTM E 2089-00, “Standard Practices for Ground Laboratory Atomic Oxygen Interaction Evaluation of Materials for Space Applications”. All substrates used for the evaluation and fluence witnesses are made of 2.54 cm diameter by 0.127 mm thick Kapton H polyimide.

The effect of minor abrasions can be observed according to the following process. An additional set of ceramer and DC 93-500 coated samples are made in the foregoing manner, and are scratched with a finger prior to atomic oxygen exposure. Samples of the silicone-coated Kapton H are punched out and vacuum dehydrated for 48 hours prior to weighing to minimize mass uncertainty due to weight loss as recommended by ASTM E 2089-00.

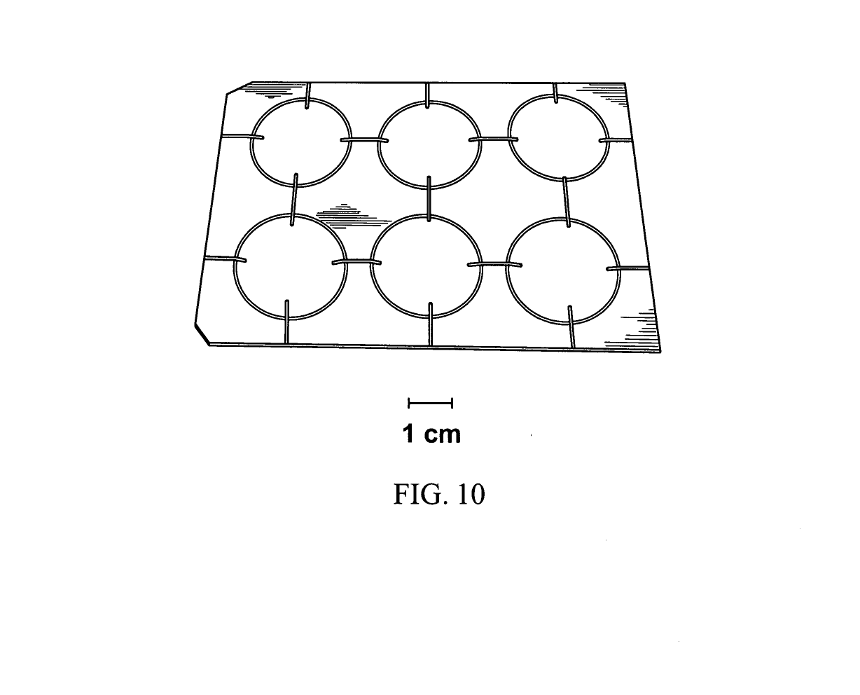

Atomic oxygen testing is performed in an SPI Plasma Prep II (13.56 MHz) radio frequency plasma asher. The asher is typically operated using air at a pressure of 20 to 26.7 Pa (0.15-0.2 torr), and a Kapton effective flux of 9.21×10¹⁵ atoms·cm⁻²/s. The samples are held down by fine wires attached to a metal frame (see FIG. 10) lying on a glass plate, which helps to limit sample curling due to atomic oxygen exposure.

Cross contamination witness samples are placed in the plasma asher next to the silicone coated samples to assess the degree of silicone transport and resulting contamination. This test is performed prior to sample exposures to determine a baseline contamination. The thicknesses of contamination deposits are measured with a Dektak 6M stylus profilometer. The profilometer scans the sample from the contamination deposit to an area that is protected from contamination by means of a tightly fitted aluminum foil mask.

Verifying the Existence of an Oxide Layer, XPS Data:

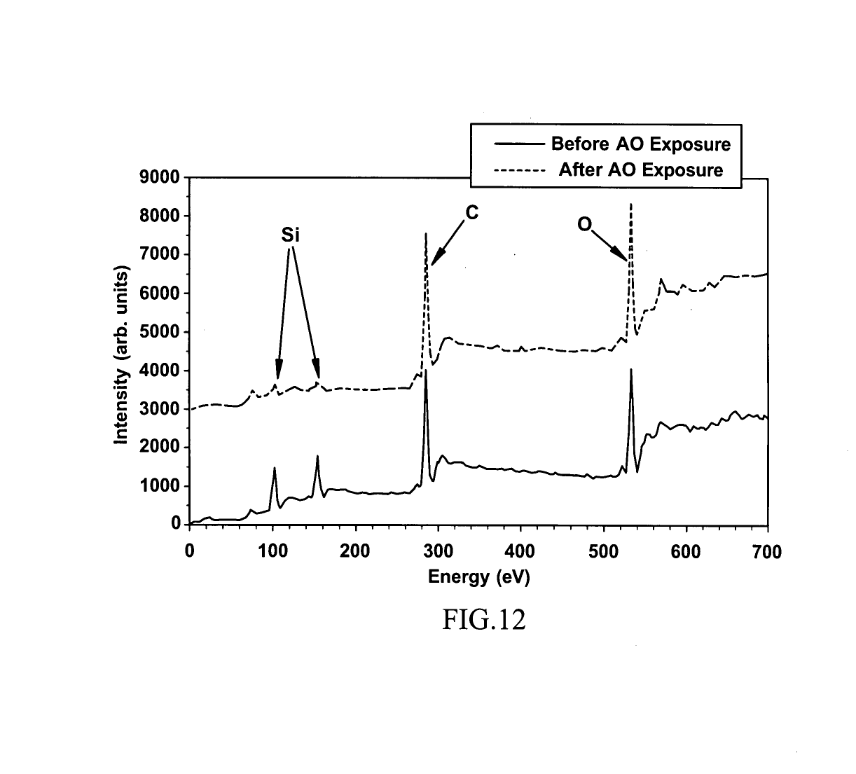

X-ray photoelectron spectroscopy (XPS) is performed to confirm the presence of a protective oxide layer (FIG. 12). Samples are not sputter-coated, thereby ensuring that only the surfaces of the samples are analyzed. The initial XPS spectrum shows high amounts of both silicon and oxygen, which is expected as these elements are present in the polymer backbone. However, after atomic oxygen exposure the oxygen peak increases while the silicon peaks decrease. This is due to the protective oxide layer possessing a high amount of oxygen compared to silicon. The oxide layer should be composed of silicon atoms whose valences are filled by oxygen atoms. Carbon is always present due to surface impurities.

Another important aspect of the coating is the presence of the silicon-oxo-clusters. It is possible to detect silicon-oxo-clusters in the cross-linked polymer network using an atomic force microscope (AFM) in tapping mode. These clusters provide additional protection against high-energy particles and deep UV-light (200-260 nm).

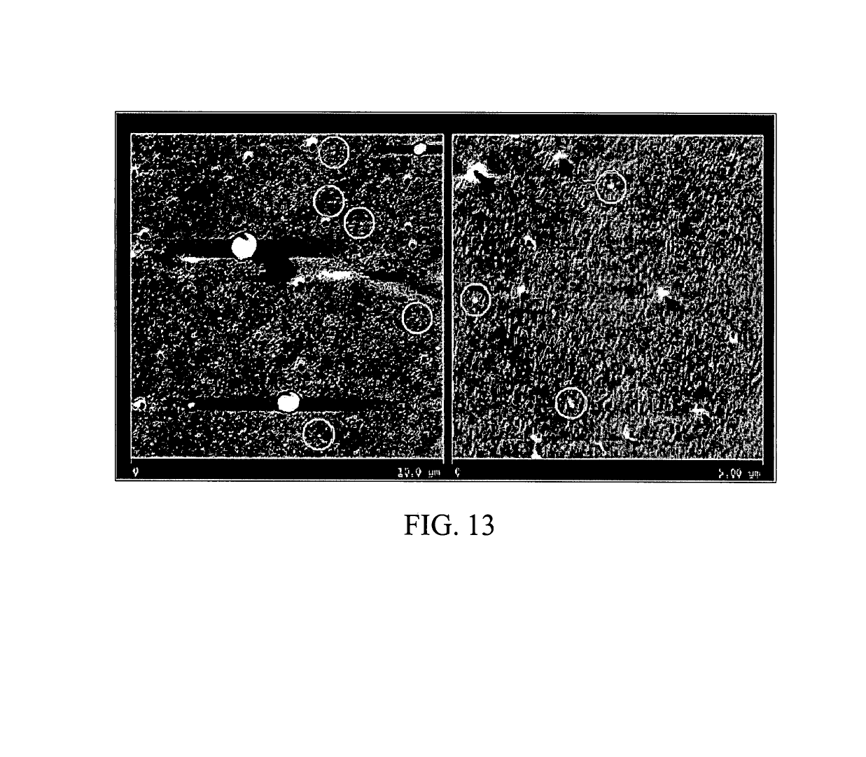

FIG. 13 is an AFM image of a ceramer within the scope of the present invention. The ceramer is made with 5% (w/w) sol-gel precursor, which is added prior to casting. The silicon-oxo-clusters are clearly visible in the ceramer sample. The clusters are circled in FIG. 13. The average size of the methyl substituted clusters is 125 nm. FIG. 13 also reveals a dispersed and uniformly sized nanophase. This can be attributed to the small size of the pendant methyl groups, which provides an unobstructed region for the growing nano-clusters.

Atomic Oxygen Exposure:

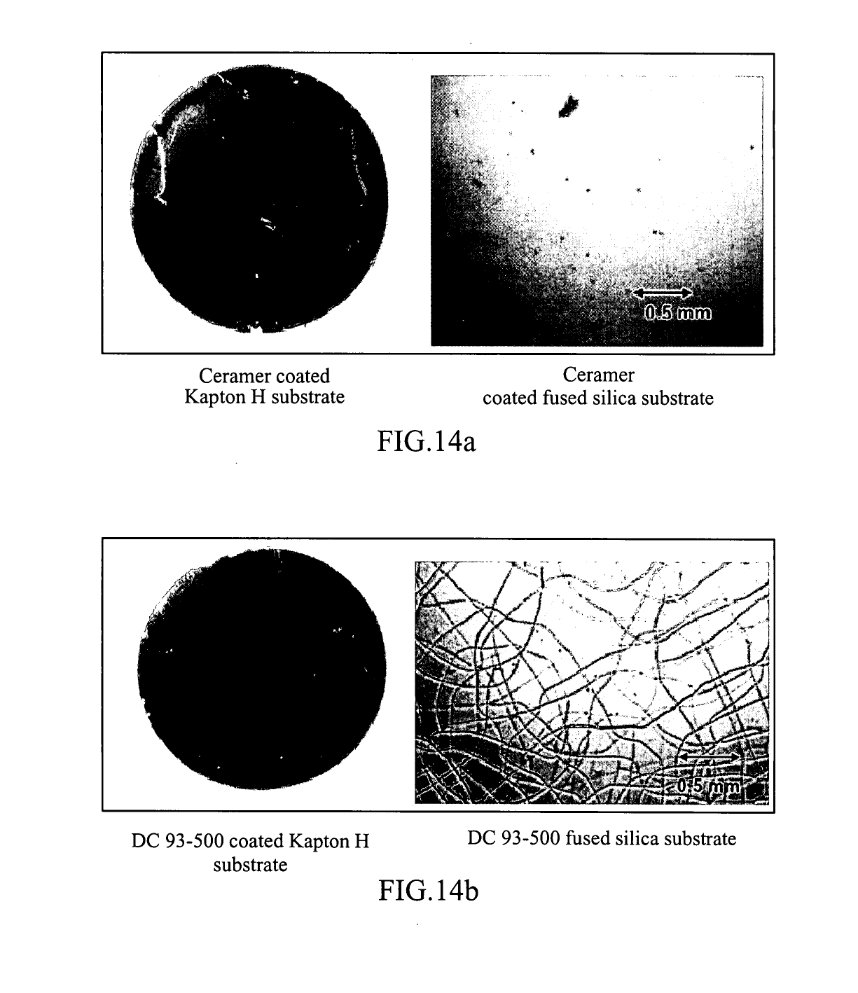

Micro-cracking and delamination of the ceramer of the present invention due to atomic oxygen is assessed. Photographs of the samples are taken after being subjected to two different fluence levels: 2.22×10²¹ and 1.38×10²² atoms/cm². FIGS. 14a and 14b show the ceramer and DC 93-500 coatings on both the Kapton H and fused silica substrates. FIG. 14a shows no evidence of micro-cracking or other physical damage at 2.22×10²¹ atoms/cm², which is a moderate fluence level. This stability is attributed to the coating's homogenously dispersed nano-phase, which allows for a more uniform distribution of the stresses caused by the growing silica layer.

In contrast, the DC 93-500 coated samples exhibit micro-cracking as shown in FIG. 14b, which is attributed to a nanophase that is less homogenous than that of the present invention. Such non-uniformity can create weak points that may yield under growing surface stresses. Coating failure is indicated by cracks propagating through the surface, as shown in FIG. 14b.

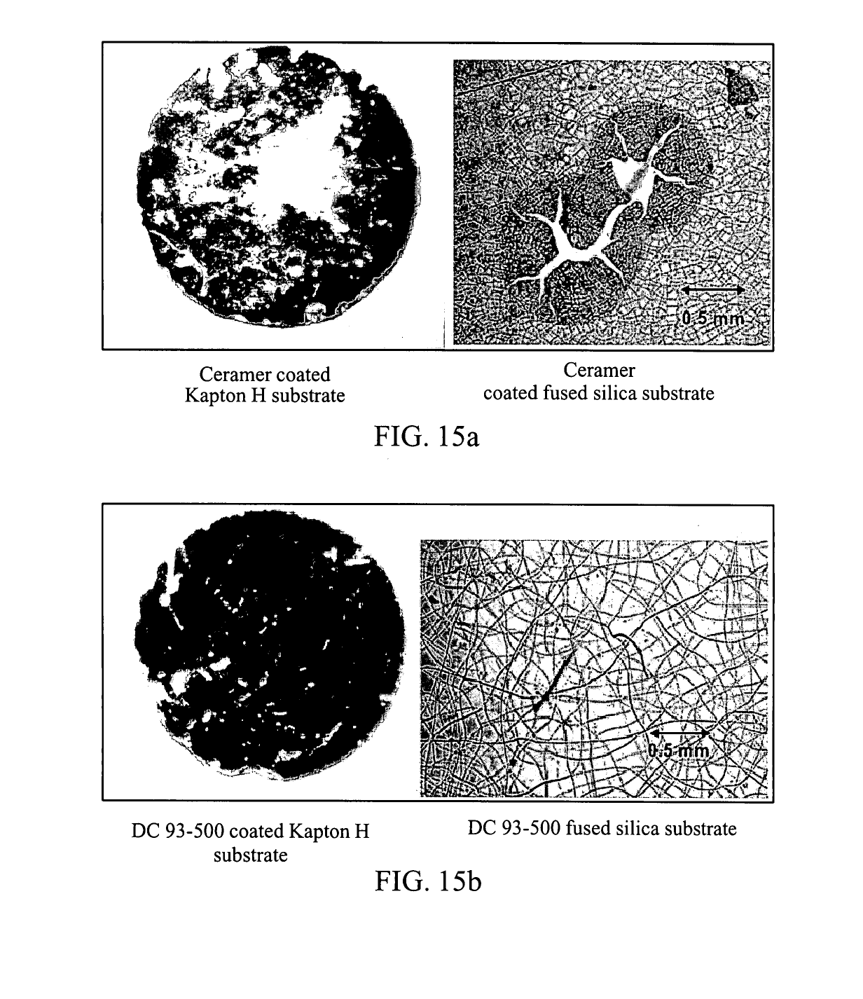

FIG. 15 is further evidence of the relative homogeneity of the present invention in comparison to DC 93-500. Both samples exhibit extreme microcracking and delamination under high fluence conditions. However, FIG. 15a shows that the present invention fails more uniformly across the entire coating. In contrast, DC 93-500 fails in scattered, isolated., regions. This indicates that the ceramer possesses a more homogenous composition. Conversely, this shows that the DC 93-500 coating has a relatively inhomogeneous composition that results in weak points.

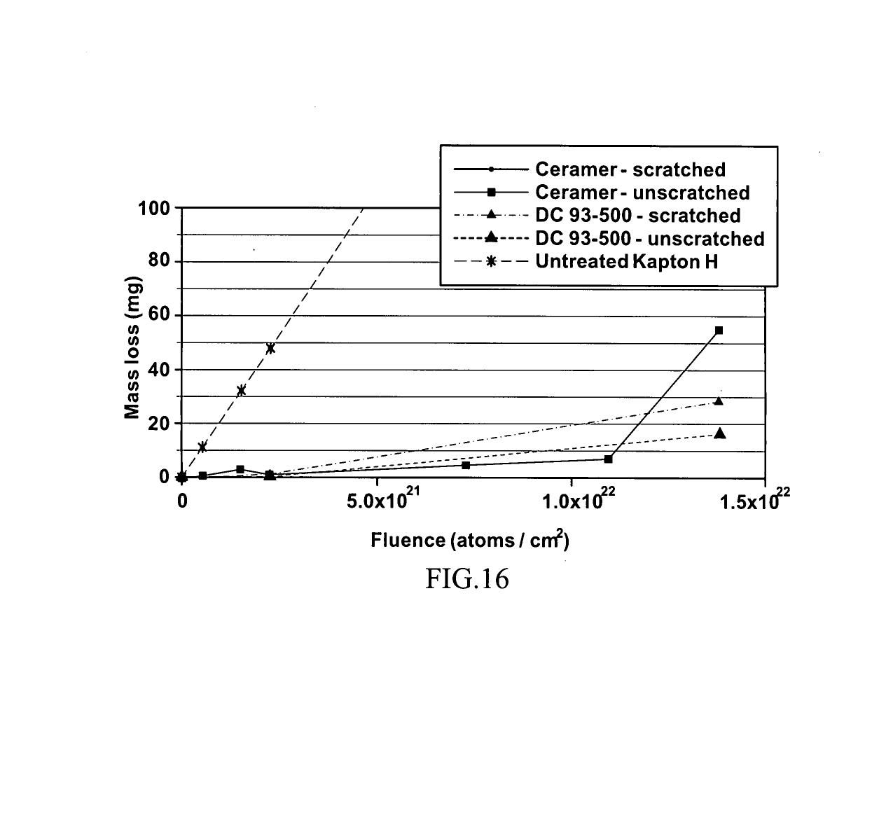

FIG. 16 illustrates the protection afforded by the ceramer coating of the present invention in comparison to that of DC 93-500 and bare Kapton substrate. Each curve shows sample mass loss as a function of atomic oxygen fluence. The uncoated sample (i.e. bare Kapton) exhibits rapid mass loss as a function of oxygen fluence. In comparison, both the present invention and DC 93-500 substantial improve atomic oxygen resistance. However, the present invention outperforms each of the other samples. Particularly, unscratched ceramer outperforms unscratched DC 93-500, and the same is true in the scratched case.

Self-Healing:

The self-healing property of the present invention can be demonstrated according to the following process. Fused silica and Kapton H substrates are coated with either the ceramer of the present invention, or DC 93-500. These samples are oxidized with atomic oxygen at a fluence of about 5.0×10²⁰ atoms/cm². Then the samples are mildly abraded with dust. Generally, the scratches produced thereby do not penetrate the coating. Thus, the effect is to remove portions of the oxide layer, exposing the underlying non-oxidized coating. The samples are then re-exposed to atomic oxygen at a fluence level of about 1.5×10²¹ atoms/cm², thereby oxidizing the scratched surface, and restoring the continuity of the oxide layer. Thus, the coating self-heals.

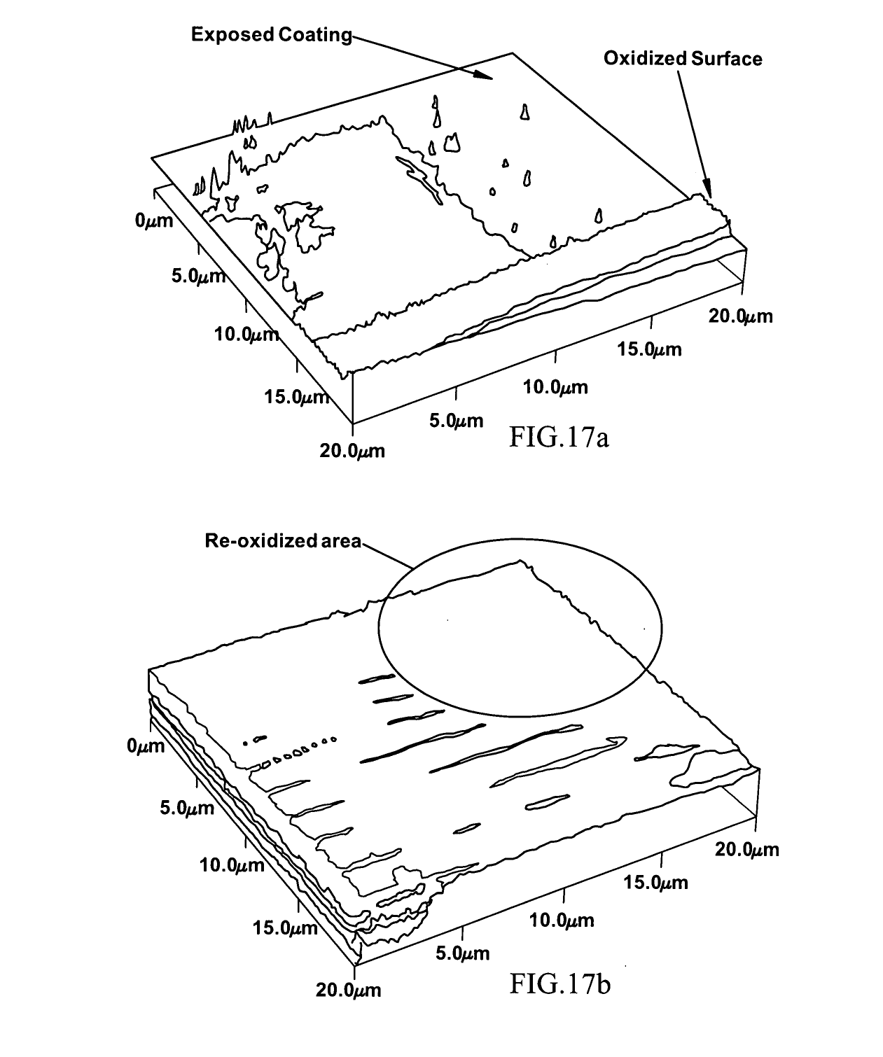

Scanning electron (SEM) and atomic force microscopy (AFM) are used to examine the self-healing process. FIG. 17a is an AFM image of the abraded coating wherein the underlying un-oxidized coating is exposed. FIG. 17b is an AFM image of the same sample after re-exposure to atomic oxygen. FIG. 17b clearly shows reformation of the oxide layer, i.e. self-healing.

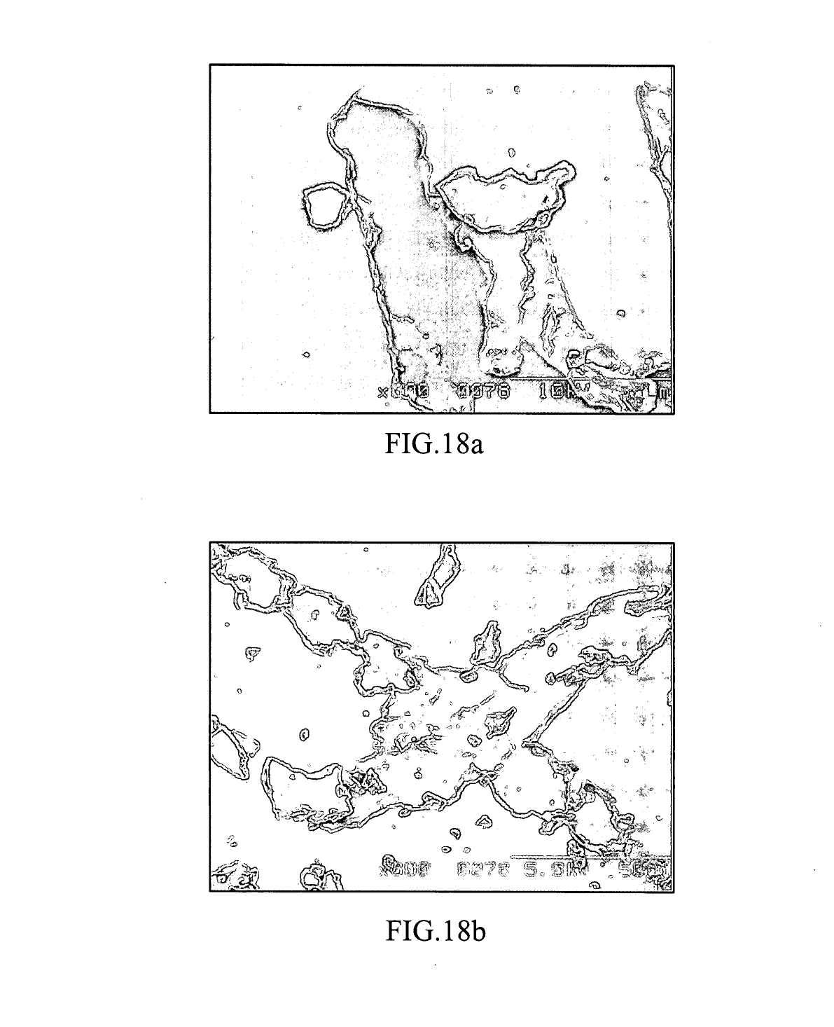

FIG. 18 is a pair of SEM images showing the ceramer coating of the present invention, on Kapton substrate, after abrasion and re-exposure to atomic oxygen. The two images are two different locations on the same sample, which are treated identically. The images reveal that no micro-cracking or under-cutting occurred upon re-exposure to atomic oxygen.

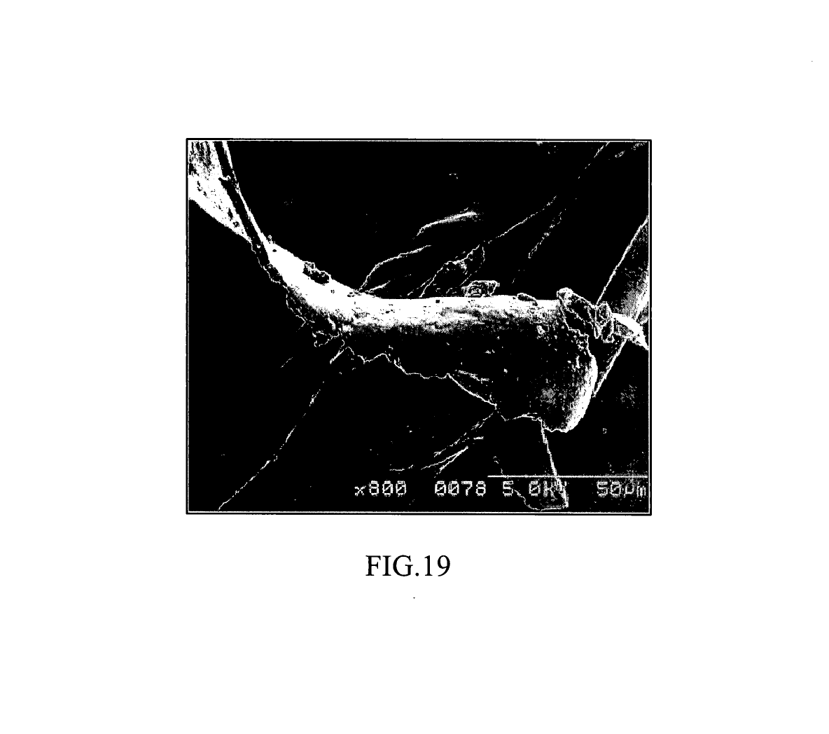

FIG. 19 is an SEM showing the ceramer coating of the present invention after abrasion and re-exposure. However, in this case the sample is subjected to high atomic oxygen fluence (1.38×10²² atoms/cm²). This image illustrates that delamination and microcracks develop as a result of high fluence. FIG. 19 also shows the underlying Kapton H substrate, which has been damaged by atomic oxygen exposure.

Oxide Formation:

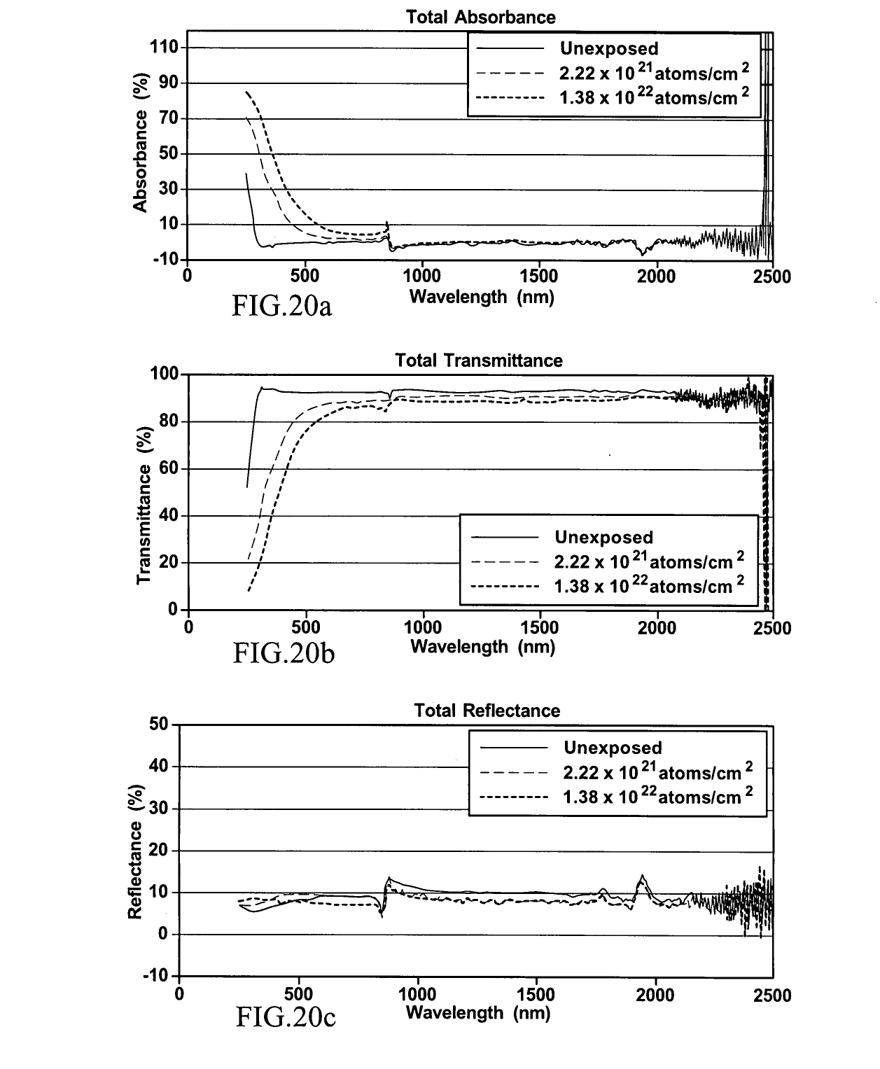

The formation of the oxide layer can be shown by UV/Vis spectroscopy. FIG. 20a shows how the absorption spectrum of a ceramer sample changes as a function of atomic oxygen fluence. Particularly, the region between roughly 250 and 800 nm where silica absorbs. The solid line represents the spectrum of the unexposed ceramer. In this case, the silica absorption is very slight. In comparison, the samples subjected to atomic oxygen, exhibit increased silica absorption as a function of fluence.

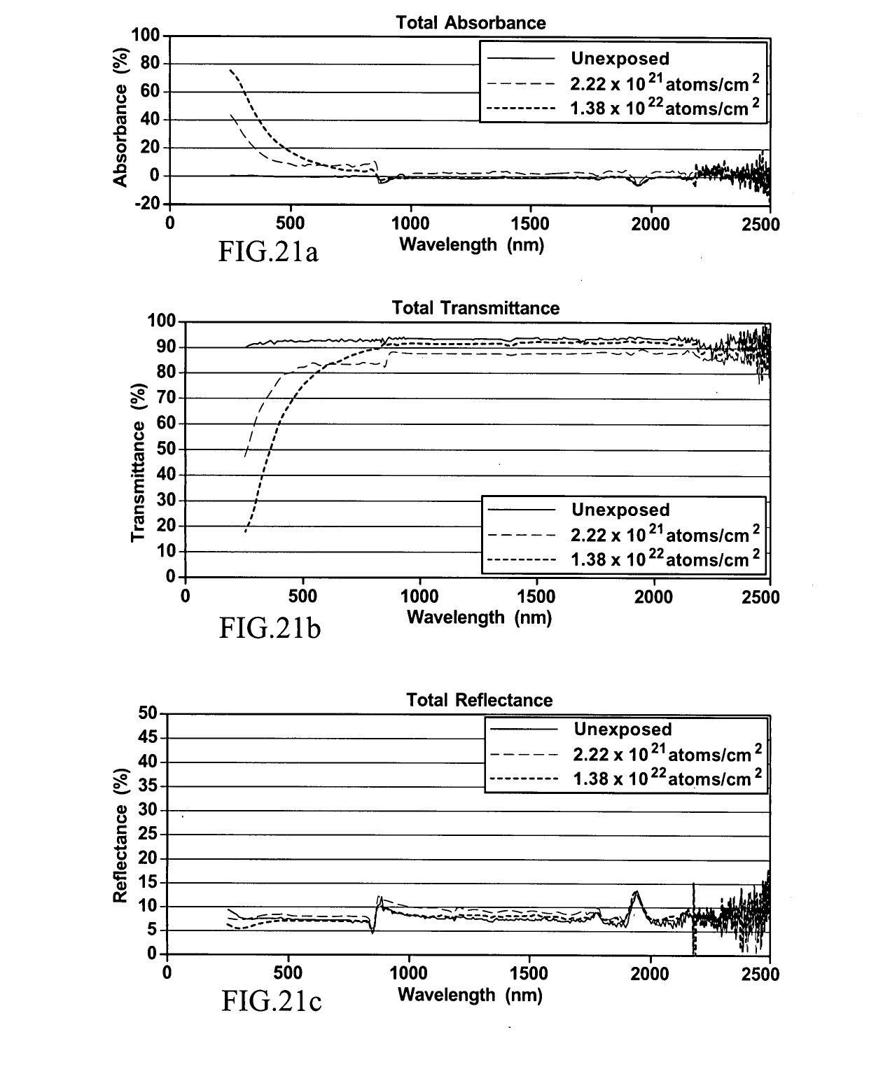

Similarly, the oxide layer produced by the DC 93-500 coating can also be studied by UV/Vis. FIG. 21a shows how the absorption spectrum of DC 93-500 changes as a function of oxygen fluence. Both samples shown therein are spin-coated on Kapton and have about 2 μm average thicknesses. Unlike the ceramer, the unexposed sample has no UV absorption at all. This is because the ceramer contains silicon-oxo-clusters while the DC 93-500 sample does not. Thus, in the absence of an oxide layer DC 93-500 does not provide the substrate with UV-protection, which could result in severe damage to materials that are sensitive to UV-radiation. Furthermore, the absorbance values for the DC 93-500 are slightly lower than the ceramers due to the lack of silicon-oxo-clusters.

Similar to the ceramer coating, the DC 93-500 transmittance values decreased with an increasing absorbance and there is no change in the reflectance. The transmittance spectra (FIGS. 20b and 21b) for both coatings show a decrease in transmittance as atomic oxygen fluence is increased, which could be attributed to micro-cracking.

In other embodiments compounds 1 or 2 are coated on the surface of a metal part in any of a variety of ways including brushing, spraying, spin-coating, and dip-coating. The part thus coated is then cured. Coated parts can be used in any of a wide variety of applications including, without limitation, space vehicles, orbiters, and satellites. In related embodiments, the coating of the present invention can serve as a protective layer in a wide variety of oxidizing environments including, without limitation, rust-proofing applications, automotive parts, and the like.

In another embodiment, the compositions of the present invention can be used to form molded parts. Such parts can include, without limitation, parts for space vehicles, orbiters, satellites, automotive parts, and parts that may be subjected to corrosive and/or oxidizing conditions.

The illustrative embodiments and examples contained herein have been prepared to demonstrate the practice of the present invention. However, the embodiments and examples should not be viewed as limiting the scope of the invention. The claims alone will serve to define the invention. Various modifications and alterations that do not depart from the scope and spirit of this invention will become apparent to those skilled in the art, and are therefore deemed within the scope of the present invention.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A ceramer composition, comprising:
a ceramic component, and;
a polymeric component is a siloxane polymer.

2. The ceramer of claim 1 wherein the ceramic component is selected from synthetic and natural silica, titania, zirconia, clays, metal oxides, and mixtures thereof.

3. The ceramer of claim 1 wherein the polymeric component is a siloxane that is functionalized.

4. The ceramer of claim 1 wherein the polymeric component comprises siloxane, wherein the siloxane is bonded to one or more functional groups selected from methyl, cyclopentyl, cyclohexyl or any combination thereof

5. The ceramer of claim 1 wherein the ceramic component comprises silicon/metal-oxo-clusters.

6. A process for preparing a ceramer composition, comprising the steps of
forming silicon/metal-oxo-clusters from sol-gel precursors using hydrolysis and condensation reactions,
forming a siloxane which is functionalized through hydrosilation with cycloaliphatic epoxides and alkoxy silanes,
mixing the clusters and siloxane, and
curing the mixture to produce and interlocking network comprising a cross-linked polymeric phase with interconnected silicon/metal-oxo-clusters.

7. The process of claim 6 wherein said clusters are formed using tetraethylorthosilicate as a sol-gel precursor.

8. A film made from the composition of claim 1.

9. A molded part made from the composition of claim 1.
